(19) United States
(12) Patent Application Publication
(10) Pub. No.: US 2010/0226203 A1
(43) Pub. Date: Sep. 9, 2010

(54) SYSTEM AND METHOD FOR UNDERWATER SEISMIC DATA ACQUISITION

(76) Inventors: David Buttle, Portugal Cove-St. Philips (CA); Neil P. Riggs, Shea Heights (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/771,608

(22) Filed: Apr. 30, 2010

Related U.S. Application Data
(63) Continuation of application No. PCT/CA2008/001912, filed on Oct. 31, 2008.
(60) Provisional application No. 60/984,754, filed on Nov. 2, 2007.

(51) Int. Cl. G01V 1/38

(52) U.S. Cl. 367/15

(57) ABSTRACT

A seismic source is provided that uses suitable low frequency acoustic transducers enabling a complex chirp to be used while increasing the effective power level and keeping the peak power down to a fraction of this effective power. The transducers can be driven using a pseudo-random coding of chirps that change frequency in each contiguous burst within the chirp and the interval between chirps varied to provide a pseudo-random duty cycle allowing multiple signals to be present in the water at the same time with a wider spectral coverage. By changing the timing of the drive signal for specific transducers, the direction of the source beam can be altered to steer the beam towards or away from certain objects or areas.

This application is a continuation of PCT Application No. PCT/CA2008/001912 filed on Oct. 31, 2008 and published under WO 2009/055918, which application claims priority from U.S. Application No. 60/984,754 filed on Nov. 2, 2007, the contents of which are incorporated herein by reference.

### TECHNICAL FIELD

The invention relates to underwater seismic data acquisition, in particular by providing an underwater seismic source using an orderly arrangement of a plurality of acoustic transducers near the seabed.

### BACKGROUND

Seismic data acquisition of sedimentary layers in a seabed beneath a large body of water such as an ocean has traditionally been used to acquire images of underlying oil fields to facilitate the recovery of oil reserves. Such data acquisition enables offshore drilling sites to be established by indicating possible locations in which to extract oil. Seismic data acquisition involves generating seismic waves from a source and receiving or “listening” to a reflected or returning wave that carries information about the medium through which it has passed.

Conventional seismic sound sources for underwater seismic data acquisition have typically operated by mechanically generating sound from the rapid release of compressed air using an air gun, or from the mechanical impact of metal on metal for some other applications.

Air guns operate near the ocean surface, often approximately 7-10 m below sea level, and operate by firing a pulse that, though partially directed downward, is essentially omni-directional. A great deal of the air gun's energy is reflected off the seabed and remains trapped in the water column. This causes two immediate problems. First, to image properly deep reservoir targets, a large energy pulse needs to be generated and since the pulse length is short for acceptable seismic resolution (i.e., the ability to image thin layers), the sound levels need to be high. This large energy pulse is central to environmental concerns for marine life.

The second problem is the high sound level trapped in the water column. As noted above, most of the energy bounces off the seabed and is reflected back toward the surface. However, the sea surface is also reflective and sends the energy back down. This echo bounces off the seabed and the process repeats itself. These water bottom “multiples” are typically very large in amplitude and tend to mask the desired reflection data from the deep sedimentary layers. Although techniques have been developed for removing these water bottom multiples, this inherently requires additional processing and risks disrupting the actual data that is desired from the original reflection.

In addition to the environmental concerns and the high sound level trapped in the water column, the use of an air gun is relatively primitive in the type and amount of data that can be carried in a reflected signal. Moreover, the air guns typically need to be dragged along behind a vessel or attached in some way near the surface of the water body, which requires additional equipment, time, and effort and could get in the way of fishing nets or any other equipment that operate in the few meters below the surface where the air gun operates.

It is therefore an object of the following to provide a system and method for underwater seismic data acquisition that addresses the above-noted disadvantages.

### SUMMARY

A system and method are described for providing an underwater seismic source for a data acquisition system that utilizes an orderly arrangement of a plurality of suitable low frequency acoustic transducers as the source.

In one aspect, there is provided a method for providing an underwater seismic source for a data acquisition system comprising locating an orderly arrangement of a plurality of low frequency acoustic transducers at a seabed; generating a drive signal for each transducer; and applying respective drive signal to respective transducers to generate the seismic source.

In another aspect, there is provided a system for generating an underwater seismic source for a data acquisition system comprising a controller at the surface, an orderly arrangement of a plurality of low frequency acoustic transducers at the seabed, and a communication link connecting the controller to the transducers, the controller configured to generate a drive signal for each transducer and to apply respective drive signals to respective transducers to generate the seismic source.

In yet another aspect, there is provided a method for generating a drive signal for creating a seismic source from an orderly arrangement of a plurality of low frequency acoustic transducers positioned at a seabed comprising: obtaining a waveform indicative of a frequency pattern at which to drive the seismic source during a chirp; transmitting an intermediate signal to the transducers according to the waveform; and utilizing a different waveform for each of a plurality of chirps.

In yet another aspect, there is provided a method for controlling a drive signal for an underwater seismic source, the method comprising: providing an orderly arrangement of a plurality of low frequency acoustic transducers in a structure at a seabed, the structure comprising an inclinometer for measuring an angle of the transducers with respect to the seabed; measuring the angle using the inclinometer; providing the angle to a controller configured for operating the transducers according to a drive signal; and adjusting the drive signal to steer a resultant beam from the source according to the angle.

In yet another aspect, there is provided an underwater seismic source comprising a structure configured to support the source at a seabed, the source comprising an orderly arrangement of a plurality of low frequency acoustic transducers; and a communication link to a controller to receive drive signals for the transducers from the controller.

In yet another aspect, there is provided an autonomous underwater vehicle comprising the underwater seismic source according to the above.

In yet another aspect, there is provided a method for generating a drive signal for creating a seismic source from an orderly arrangement of a plurality of low frequency acoustic transducers comprising generating a waveform indicative of a frequency pattern at which to drive the seismic source by: defining a plurality of chirps; and separating the plurality of chirps in the waveform according to a plurality of intervals.

### BRIEF DESCRIPTION OF THE DRAWINGS

An embodiment of the invention will now be described by way of example only with reference to the appended drawings wherein:

FIG. 1 is a schematic diagram of an underwater seismic data acquisition system using a transducer arrangement at the seabed.

FIG. 2a is one embodiment of a structural frame for the transducer arrangement shown in FIG. 1.

FIG. 2b is another embodiment of a structural frame for the transducer arrangement shown in FIG. 1.

FIG. 3 is a plan view of an N×M array of transducers supported in the structural frame.

FIG. 4 is an elevation view of the transducer array of FIG. 3, supported in the structural frame.

FIG. 5 is a cross-sectional schematic view of a transducer assembly.

FIG. 6 is an exaggerated cross-sectional schematic view of the transducer assembly of FIG. 5 during operation.

FIG. 7 is a schematic diagram showing the formation of a sonar beam generated using the exemplary transducer array shown in FIGS. 4 and 5.

FIG. 8 is a schematic diagram showing the formation of a directed sonar beam.

FIG. 9 is a functional schematic diagram of the system shown in FIG. 1.

FIG. 10 is a timing diagram illustrating pseudo random chirps using pseudo random intervals.

FIG. 11 illustrates one chirp in isolation.

FIG. 12 illustrates a set of contiguous bursts taken from the portion A of the chirp shown in FIG. 11.

FIG. 13 illustrates the generation of a stacked signal from individual signals at different frequencies.

FIG. 14 illustrates a transducer arrangement having an inclinometer for detecting irregularities in the seabed for operating a beamsteering method.

FIG. 15 illustrates a towable transducer arrangement.

### DETAILED DESCRIPTION OF THE DRAWINGS

It has been recognized that by using a suitable low frequency acoustic transducer placed at the seabed and directed into the seabed, technological sophistication can be introduced to seismic data acquisition. It has also been recognized that such acoustic transducers, by generating much lower sound levels than conventional air gun sources can provide improved data quality and resolution and well as mitigate environmental damage associated with seismic oil exploration.

The following illustrates that acoustic transducers, when suitably configured, allow the transmission of complex sound sources which can be processed for a wide range of applications by any conventional and existing receiver. In particular, complex ‘chirps’ can be detected by applying sonar de-coding and pulse compression algorithms, even when the chirps are buried in ambient noise levels, e.g. a signal-to-nose ratio of <1. It has been found that such chirps can be applied to deep reflection seismic exploration, even at relatively higher frequencies than traditional solutions such as air guns.

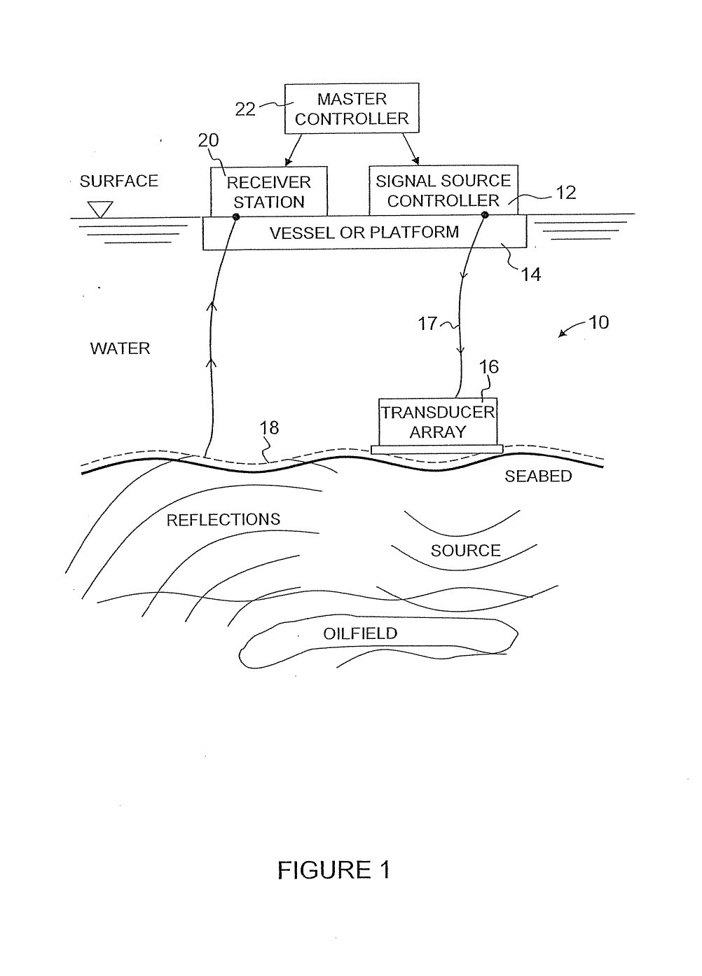

Turning now to FIG. 1, an underwater seismic data acquisition system is generally denoted by numeral 10. The system 10 comprises a signal source controller 12 supported at, e.g. the ocean surface, by a vessel or other platform 14, and a transducer arrangement 16 located at the seabed. The transducer arrangement 16 comprises an orderly arrangement of a plurality of individual low frequency transducer assemblies that are collectively used as a seismic source. Such orderly arrangements may include linear arrangements, circular arrangements, star-pattern arrangements, N×M array arrangements, etc. The transducer arrangement 16 can thus provide any configuration and orientation of transducers that suits a particular application. As such it will be appreciated that any particular arrangements shown or described herein are purely for illustrative purposes.

The controller 12 and transducer arrangement 16 are communicably connected by a connection or link 17 such as a cable extending from the platform 14 to the transducer arrangement 16. The link 17 may also be provided through appropriate wireless configurations or any other available telemetry configuration. The controller 12 operates to cause the transducer arrangement 16 to generate a sonar beam or ‘source’ from a set of suitably low frequency acoustic transducers, that penetrate the material in the seabed, which is reflected back through the rock and other earthen material in the seabed and these reflections may then be detected and analyzed. It has been found that suitably low frequencies can include sub-1 kHz transducers, sub-200 Hz transducers and transducers capable of operating at as low as 100 Hz.

To achieve such low frequencies, suitable transducer types should be chosen. Such transducer types may include any available acoustic transducer as well as similar ones yet to be developed. As will be exemplified below, it has been found that piezoelectric transducers, in particular those using ceramic elements (also known as “piezoceramic” transducers) can achieve the desired low frequencies. It will be appreciated that various other transducer assemblies such as magnetorestrictive, flextensional, barrel stave, etc. can also be used.

In the example shown in FIG. 1, the system 10 is being used to survey an offshore oil field located within the seabed. Also shown in FIG. 1 are a hydrophone 18 often called a ‘streamer’ for capturing the reflected sonar waves and for sending data associated with the reflected waves back to a receiver station 20 comprising equipment for storing, analysing or otherwise processing the received information. A master controller 22 may also be used to command the controller 12 to operate in a particular way (i.e. according to a particular code or pattern) while ensuring that the receiver station 20 knows which patterns or codes have been used and in what order so that they may be interpreted either in real time or at a later time as will be explained in greater detail below. The source controller 12 can be told which pattern or code to use and/or if any beam steering is required and then the source controller 12 can tell the master controller 22 what has actually been sent, or the master controller 22 can simply then tell the receiver station 20 what to expect based on what it told the source controller 22 to do. It may be noted that any processing at the receiver station 20 can be done in real-time or at a later time by storing the received information and ‘de-chirping’ according to what the master controller 22 indicates has been sent by the source controller 12.

It will be noted that the receiver station 20 and streamer 18 can be any commercially available equipment and may be existing equipment that is normally used with other sources. As will be explained below, the signal source controller 12 and transducer arrangement 16 enable such existing equipment to be used without any modifications thereto, only knowledge of what is being sent by the system 10, which is generally under the control of the master controller 22 where appropriate. It may also be noted that the receiver station 20 typically detects reflections from multiple receiving apparatuses (not shown).

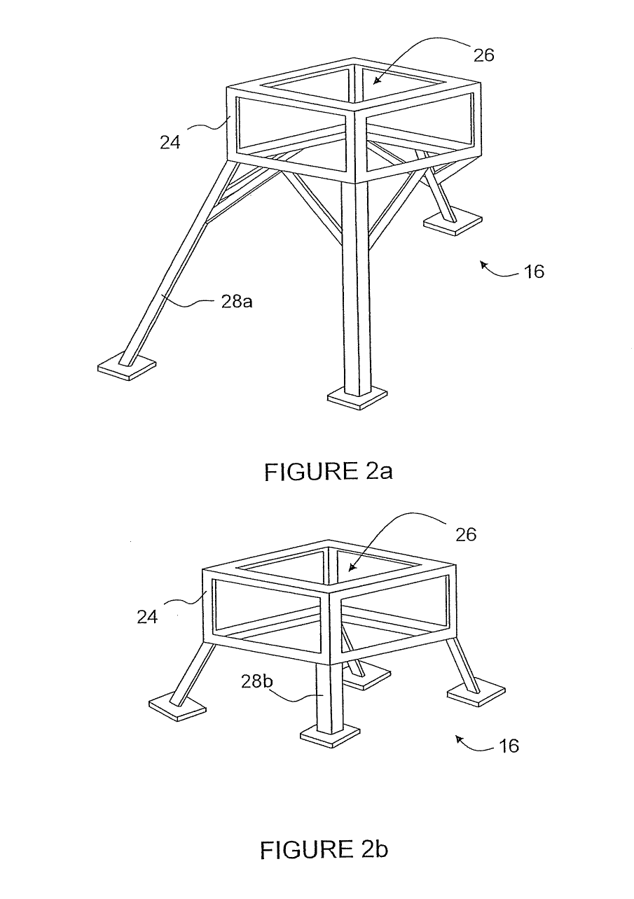

The transducer arrangement 16 is deployed such that it is supported directly on or elevated just above the surface of the seabed at the bottom of the body of water. There are many different structures which may be used to support the transducer arrangement 16, examples of which are shown in FIGS. 2a and 2b. In FIG. 2a, a skeletal rack 24 is used to mount, support and separate each transducer in the transducer arrangement 16 and is itself supported by a set of legs 28a. The legs 28a are sized to place the rack 24 and thus the transducer arrangement 16 a specific distance above the seabed. In FIG. 2a, the legs 28a are configured to provide a separation between the transducer arrangement 16 and the seabed such that a sonar beam will completely form before meeting the seabed. The exact separation will depend on the nature of the transducers being used, the number of transducers used, and sometimes the expected material that is to be penetrated. Where the transducer arrangement 16 is supported in this way, a distance of approximately 2 times the wavelength (λ) of the source beam is a practical distance. However, it may be noted that ½λ, may be suitable and ideally, the distance would be 4λ. It can also be seen that in this example, three legs 28a are provided to improve stability to compensate for an irregular seabed.

In FIG. 2b, the rack 24 is supported just above or substantially “on” the seabed by a set of relatively shorter legs 28b (when compared to FIG. 2a). In this example, the arrangement 16 is supported such that the source beam is directed substantially immediately into the seabed and thus the beam forms within the seabed. It will be appreciated that either alternative (FIG. 2a or 2b) can be used depending on the environment and the application, however, careful consideration of the distance between the arrangement 16 and the seabed should be made, in order to optimize the efficiency of the source.

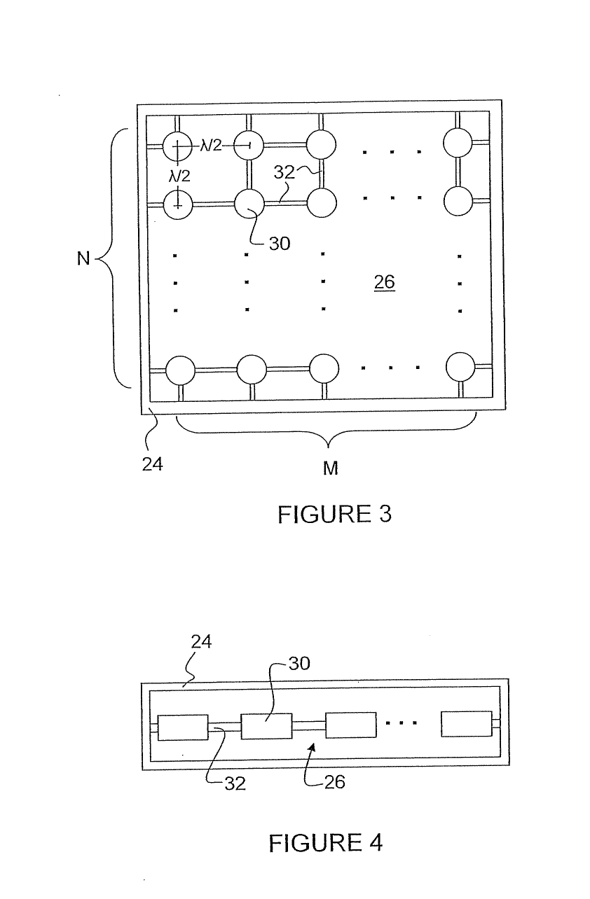

Turning now to FIGS. 3 and 4, the transducer arrangement 16, as supported by the rack 24, is shown in greater detail. The arrangement 16 in this example is an array comprising N rows of M transducer assemblies 30. Typically, for this embodiment N=M (i.e. N×N array), however, N and M may be different if different beam characteristics are required. Similarly, either N or M may be equal to one thus providing a linear array. Again, it will be appreciated that the array configuration is only for illustrative purposes and other arrangements can be used such as star patterns, spiral patterns, etc. As will be explained further below, the greater the number of transducer assemblies, the more powerful the source. As can be seen in FIGS. 3 and 4, each transducer assembly is supported and spaced from each other using a series of supports 32, which can be of any size and configuration. It may be noted however that the rack 24 and supports 32 should not obstruct the upper and lower surfaces of the transducer assemblies 30. The spacing between the transducer assemblies 30 should be one-half of the wavelength of the source signal (½λ). This spacing facilitates the formation of a single beam from the contributions of each of the transducer assemblies since sonar and antenna arrays need to use a spacing of no more than ½λ. This is because a spacing greater than ½λ, although providing desirable narrow beams, generate multiple beams in spurious directions which are undesirable. In one example, an array of 16 piezoelectric transducers may be used, in a 4×4 matrix, each capable of transmitting in a range around 800 Hz (e.g. a 100 Hz bandwidth between 750 Hz and 850 Hz). In this example, the spacing between each transducer assembly 30 would be slightly less than 1 metre (i.e. ½λ for an 800 Hz sound in water). The rack 24 would in this case be approximately 3 metres by 3 metres. It will be appreciated that the larger the arrangement 16, the larger the rack 24 that is needed.

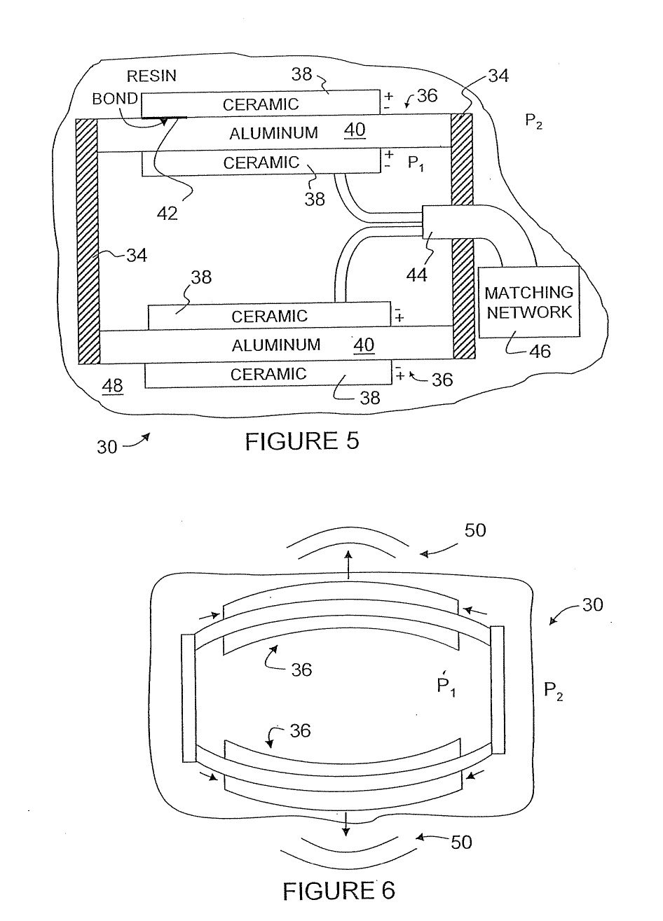

The transducer assemblies 30 comprise one or more piezoelectric transducers that convert electrical energy into a displacement which, in a medium-impedance material such as water, translates to a relatively larger force for a relatively small displacement. In one example, the transducers used are piezoceramic bimorph or ‘bender’ type sonar transducers as shown in FIGS. 5 and 6, however, it will be appreciated that any other suitable acoustic transducer may be used, such as magnetorestrictive, flextensional or barrel stave transducers. The choice of which type of transducer to use is typically dependent on the desired bandwidth (as the transducers in whatever form have a limited bandwidth) and the cost constraints. These decisions may be affected by the total number of transducers in the arrangement 16 and the desired sophistication of the system 10. As will be explained below, the piezoceramic transducers utilize ceramics bonded to a disk that is forced to move within the medium due to constrained movement of the ceramics when a high voltage is applied.

Turning now to FIG. 5, in the example shown, each transducer assembly 30 is constructed using a pair of bender transducers 36, one fixed at each end of a cylindrical housing 34. The transducers 36 separate the interior of the assembly 30 from the exterior of the assembly and define an internal cavity having a first pressure P₁. As is well known in the art, each bender type transducer 36 is comprised of a pair of ceramic disks 38, each bonded to one side of an aluminium plate 40. In a typical example, the ceramic disks 38 are approximately 100 mm in diameter and approximately 3 mm thick, and the aluminium plate 40 is slightly larger in diameter and of a similar thickness. Each transducer 36 is wired such that the application of a high voltage across the ceramic disks 38 causes each disk 38 to expand in both thickness and diameter and, due to the bonding between the disks 38 and the respective plate 40, the plate 40 constrains radial expansion and thus causes the whole transducer 36 to bend outwardly as shown in FIG. 6. This forms a mechanical lever which translates the small radial expansion of the ceramic 38 into the much larger axial movement of aluminium plate 40.

The wiring for the transducers 36 is fed through a passage or relief 44 to an external matching network 46. The matching network 46 contains circuitry, most notably a transformer, that matches the impedance of the transducer to that of the cable 17. This enables a more manageable voltage to be sent down the cable 17. Typically, the matching network 46 contains a transformer that can provide approximately on the order of 1000 of impedance on the cable side and approximately 1-2 kΩ on the transducer side. As can be seen in FIG. 5, the entire assembly 30 is coated in a resin or other water-resistant barrier 48 to prevent leakage. The cable 17 should be chosen to accommodate all N×M channels. In a 4×4 array, a 16 way twisted pair cable can be used. The underwater end of the cable 17 in this example would have a 32 way underwater connector to attach it to a transformer housing (holding the matching networks 46) on the arrangement 16 (not shown). The surface end would then be fitted with a 32 way dry connector. The cable length should accommodate the depth of water into which the system 10 is deployed.

It has been recognized that for deep-sea deployment (e.g. 500 metres), the configuration shown in FIG. 5 would result in a much higher external pressure P₂ than internal pressure P₁. When this difference in pressure is too high, the transducers 36, in particular the ceramic disks 38, will certainly be damaged due to high stresses. To compensate for this situation, the transducer assembly 30 should be equipped with a pressure relief system or some other technique to balance the internal and external pressure. One way to achieve this would be to have a fluid filled internal cavity. Another way to achieve this would be to provide a demand valve such as those used in scuba diving. In this way, external pressure increases due to the submersion of the transducer assembly 30 will be balanced thus minimizing the stresses on the internal components, in particular the ceramic disks 38.

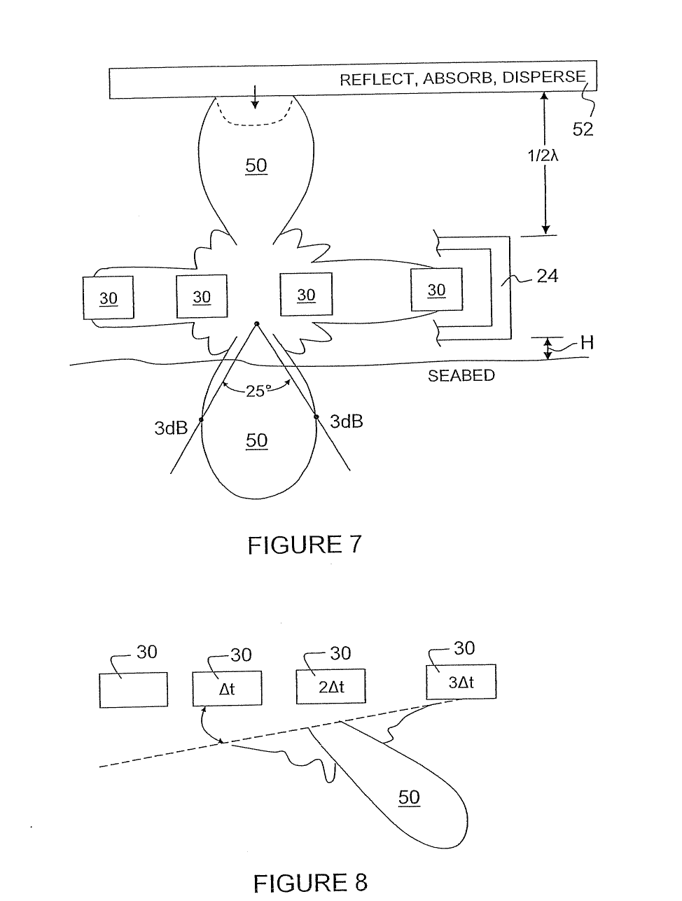

The configuration shown in FIG. 5 causes a near omni-directional sonar beam for each transducer assembly 30, which, when placed side by side in the arrangement 16 as shown in FIGS. 3 and 4, focuses the beam 50 towards the centre of the arrangement 16 as shown in FIG. 7. In general, the more transducers in the arrangement 16, the more focussed and thus more powerful the beam 50. Although four transducer assemblies 30 (i.e. array of 16) are shown in FIG. 7, this is for illustrative purposes only and any number of transducer assemblies 30 in any size of arrangement 16 can be used. When operated or ‘fired’ as shown in FIG. 6, the outward movement of each transducer 36 causes an upward beam 50 and a downward beam as shown in FIG. 7. In order to minimize the environmental impact of the upwardly directed beam 50, and to utilize as much of the generated power as possible, a reflector 52 is placed above the transducer arrangement 16 made of, e.g. syntactic foam. The reflector 52 is placed ideally approximately ½λ above the arrangement 16 such that the reflected beam is in phase with the downward directed beam 50 when they meet as the upwardly directed beam changes to a downward direction. Alternatively, an absorption or dispersion mechanism can instead be used to minimize the environmental effects of the upwardly directed beam 50.

As shown in FIG. 7, the beam 50 has certain characteristics, namely an angular ‘width’ and bandwidth. For a 4×4 array, the beam 50 can be focussed to provide an approximately 25 degree wide beam and, with a mechanical Q of about 8, will allow a −3 dB transmission bandwidth of about 100 Hz with a centre frequency of 800 Hz as shown in FIG. 7. It can be appreciated that a larger array would produce a narrower beam (more powerful) whereas a smaller array would produce a wider beam (less powerful).

It may be noted that the beams 50 shown in FIG. 7 are directed normal to the transducer assemblies 30 only when each transducer fires at exactly the same time at exactly the same frequency. Although it is desirable to fire each transducer 36 at the same time to combine the power of each, the timing of each signal for each transducer assembly 30 may be altered as shown in FIG. 8 such that the beam 50 is directed accordingly. As shown in the example in FIG. 8, an arbitrary delay along the row of transducers 36 causes the beam 50 to build towards one end and thus directs the beam that way. As will be explained below, this capability can be harnessed to provide further flexibility in what can be surveyed using the system 10. Again, by using suitable low frequency acoustic transducers 36 (e.g. piezoceramics), not only can more complex signals be transmitted, but time shifting can cause the beam to be directed or ‘steered’ towards or away from objects in the field. This directional beam shifting enables the progression of an oilfield to be tracked as movement of the oil source in the seabed can be detected, even when the arrangement 16 is situated in the same location.

In order to produce the desired sonar beam 50 using the arrangement 16, the signal source controller 12 is configured and programmed to drive each transducer assembly 30 in a particular way, according to a particular code or pattern. By using the suitable low frequency acoustic transducers described herein as the seismic sound source, it is possible to transmit complex signals. The following examples involve the use of the piezoceramic technology exemplified above but it will be appreciated that the same principles can be equally applied to other transducer types.

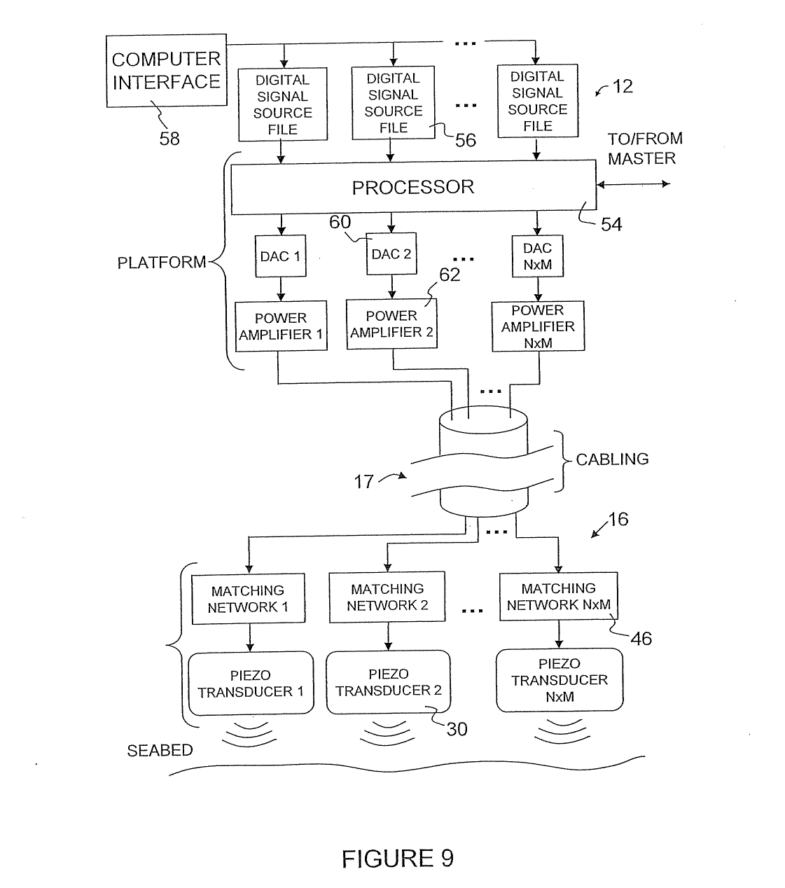

FIG. 9 shows a schematic diagram of the circuitry that can be used to drive each transducer assembly 30. At the surface or platform 14, the controller 12 drives a separate channel for each transducer assembly 30 in the arrangement 16, thus N×M channels are used in this example. The controller 12 includes a main processor 54, which is responsible for creating a drive signal by ‘playing back’ a stored digital signal source file 56 that dictates the manner in which each transducer 36 will fire during a transmission. Typically, each file 56 is stored separately so that each transducer 36 can be fired with different timing patterns so that the beam can be directed or steered. It will be noted, however, that for the beam 50 to form as shown in FIG. 7, each transducer 36 should be fired with the same frequency pattern (although this pattern can change for each chirp as explained below). The files 56 can be pre-stored in a library or can be uploaded or downloaded in real time or in any way that is suitable to the particular application. A computer interface 58 is preferably provided to enable new wave files 56 to be added and for files to be edited, or patterns changed etc. A communication connection with the master controller 22 is also provided so that the source controller 12 can be told which pattern or code to use and/or if any beam steering is required and then the source controller 12 can tell the master controller 22 what has actually been sent, or the master controller 22 can simply then tell the receiver station 20 what to expect.

The processor 54 reads each file 56 and creates a corresponding drive signal for each channel, namely one per transducer assembly 30. Again, the frequency pattern for each channel will be the same, but may include time delays to direct the beam in a particular manner. The processor 54 outputs a digital signal for each channel, which are converted to respective analogue signals using corresponding digital-to-analogue converters (DAC) 60. Each drive signal is then powered by a power amplifier 62 which, for example, provides a 100 Watt output to be transmitted down the cable 17 to the arrangement 16. At the seabed, in the arrangement 16, the matching networks 46 match the transducers 36 to a non-reactive impedance. The drive signal then fires the transducer assemblies 30 according to the pattern in the digital wave file 56, at the specified timing for that channel, which builds a sonar beam 50 that is directed into the seabed as shown in FIGS. 7 and 8.

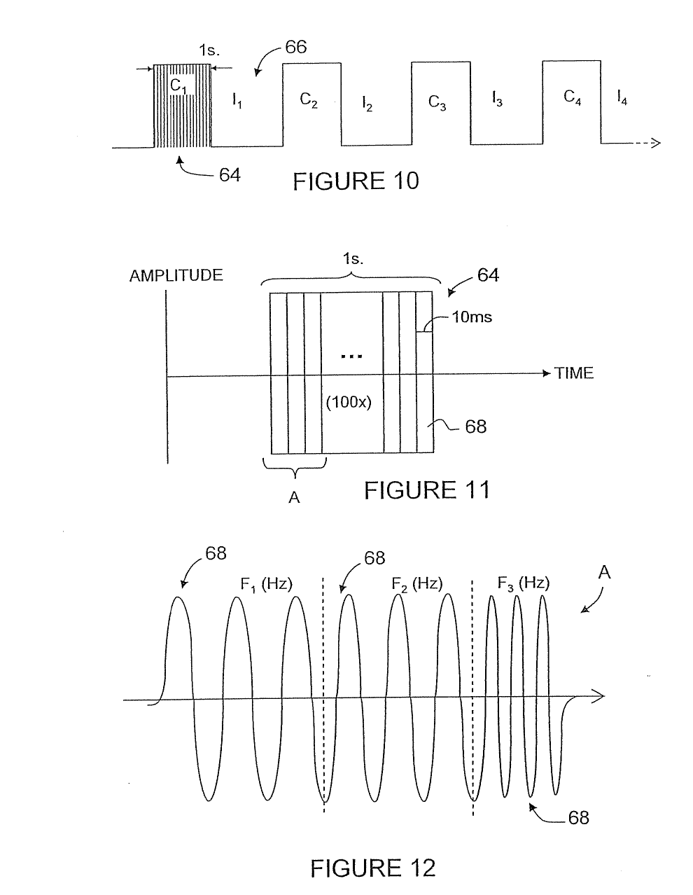

The drive signal to be transmitted is advantageously a swept frequency burst commonly referred to as a ‘chirp’. A chirp is a signal in which the frequency increase or decreases in time. The transitions from one frequency to the next define a series of bursts. For simplicity, the following will assume each chirp 64 lasts 1 second, with 100 contiguous bursts 68 in each chirp as shown in FIG. 10. It can also be seen in FIG. 10 that preferably, the interval (I) between each chirp (C) can be made different. In this way, not only can the frequency pattern within each chirp be pseudo-random, but also the pattern in which the chirps 64 are transmitted (duty cycle) can also be pseudo-random. In this way, a more complete spectral coverage can be obtained since using a pseudo random burst spreads the spectrum, which helps with resolving multiple pulses in the water/ground at the same time. If each transmission was the same as the previous one, the system 10 would have to wait for echoes from the first burst to disperse before transmitting another burst to prevent echo confusion. It will be appreciated that pseudo-random in this embodiment refers to the fact that a pattern can be imposed by the sender such that only a receiver who knows this pattern (in other words has the key to the code), can make sense of or decipher the received signals.

It may be noted that in typical sonar applications, a 1 second long pulse would mean that the range resolution would be approximately 750 metres for a two-way path at a speed of sound in water of 1500 metres per second. This would normally be considered unacceptable in the environment shown in FIG. 1. The power in the pulse would be, in the 4×4 array example, 16 transducers×100 watts for 1 second, the equivalent of 1.6 kJ in seismic terms. However, because in the system 10, the power is transmitted in the form of a narrow beam (due to the arrangement of the transducer assemblies 30 in the arrangement 16), the effective power is increased by the Directivity Index of the transducer. This gives a sound source equivalent to 40 times 1.6 kJ (i.e. 64 kJ), which is generally sufficient for seismic applications. The 100 Watts to be transmitted per transducer 36 is not a fixed value, the transducers 36 would typically be capable of more power.

FIG. 11 shows a single chirp 64 in isolation to illustrate a set of contiguous bursts 68 within a single chirp 64. In this example, with a 1 second chirp having 100 contiguous bursts, each burst will last 10 ms. In each burst 68, a different frequency is used, as illustrated in FIG. 12. Again for simplicity, assuming a bandwidth of 100 Hz for each transducer 36, with the capability of a 1 Hz resolution, each chirp can sweep through 100 different frequencies, in 1 Hz steps. In a simple example, as illustrated in FIG. 12, the frequency in each burst 68 changes by a certain frequency step (either same step each time or pseudo-randomly changing step) from a first frequency (in the first burst) to a final frequency (in the last burst). In the example shown in FIG. 12, three bursts are shown, which change in frequency from F₁ to F₂ to F₃. It will be appreciated that the frequency may change in step from low to high or may be randomly changed as noted above.

By using a different frequency in each burst, the 1 second chirp, when de-chirped, can be condensed into a 10 ms ‘stacked’ burst that provides a power level that is increased by a factor of 100 (20 dB) while keeping the peak power down to 1/100^{th} of this. In order to take advantage of this, each 1 second chirp is sampled and a discrete Fourier transform (DFT) is applied. The DFT can be applied using a digital signal processing (DSP) system, which are commonly used in existing receiving systems. The incoming waveform is separated into 100 bins, each representing 1 Hz of the swept frequency that was transmitted. This is repeated after the specified interval I.

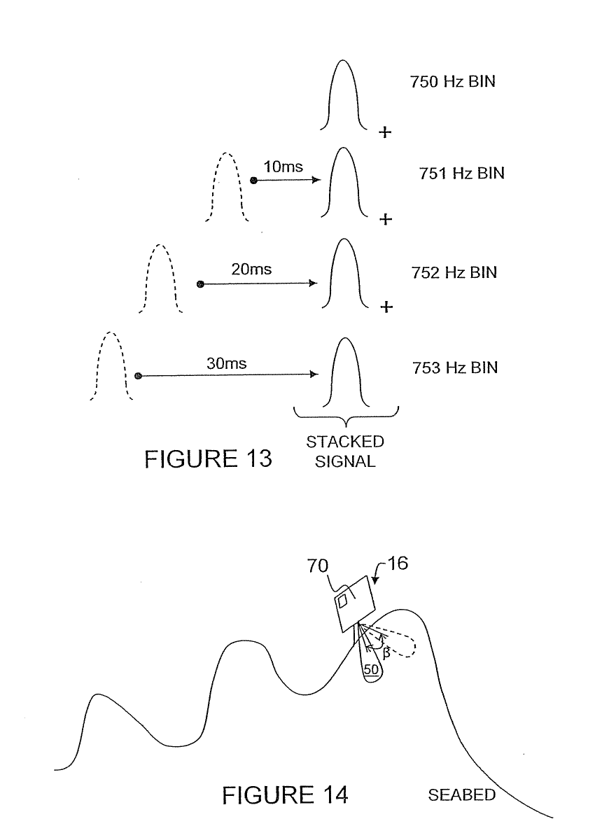

Turning now to FIG. 13, a specific example is shown where the chirp sweeps from 750 Hz to 850 Hz in 1 Hz increments. In this example, the energy in the first bin (750 Hz) is added to the energy in the second bin (751 Hz) by sampling this frequency 10 ms later. The energy from the third bin (752 Hz) is then also added by sampling that frequency 20 ms later than the first bin, the energy from the fourth bin (753 Hz) is then added by sampling that frequency 30 ms later than the first bin and so on for each bin. This effectively stacks the power from each individual signal into a combined signal having 100 times the power as noted above. It will be appreciated that the manner in which the offsets between the bins are implemented is done according to the pattern in the drive signal. In this simple example, each burst 68 increases in frequency by 1 Hz compared to the previous burst 68 and thus each bin is sampled an order of 10 ms later than the first bin. As such, the delays that are applied are performed according to the known pseudo-random pattern of the burst frequencies within the chirp 64.

It may be noted that the speed of sound in rock is approximately three times that of seawater. As such, the effective resolution of the de-chirped signal in this system 10 is approximately 22 metres, which is superior to that of existing seismic sound sources such as air guns.

To implement a pseudo-random drive signal, any pattern can be used so long as the order in which the frequencies change and to what value they change is known, so that the signal can be decoded or de-chirped by the receiver. Each pattern in each chirp 64 can be changed each time or can be repeated. However, it will be appreciated that when each chirp 64 is different, the controller 12 does not have to wait until the previous signal dies out before transmitting the next, since each signal is inherently different and can be picked out by the receiver from background noise etc. As such, the pseudo-random coding of the chirps 64 allows multiple chirps 64 to be present in the water at the same time.

In general, the chirp 64 may be represented by the following function:

g(t)=sin(2πft); where f changes for each burst 68.

In the example above, f=750+100t where t is any value between 0 and 1 with a 0.01 s (10 ms) step. In this way, f(t) changes from 750 to 850 over the course of 1 second. It will be appreciated that the above equation for f would be different for each coding scheme used.

As noted above, the bursts 68 can be sequential in frequency as exemplified in FIGS. 12 and 13, but can also be given different patterns. The sequential 10 ms bursts can use any of the 100 frequencies available in this example, in any order. This means that there can be 100 factorial combinations or codes in the pseudo-random coding scheme. As long as the receiver knows which code was transmitted, it can separate them. The pseudo-random coding allows multiple 1 second transmissions or chirps 64 to be present in the rock etc. simultaneously, with the receiver able to distinguish between them. This, in combination with a pseudo-random variation to the intervals between the chirps 64, enables greater spectral coverage. It will be appreciated that the above examples are for illustrative purposes only and that the bursts 68 may be shorter or longer depending on the bandwidth of the available/chosen transducers 36. For example, a 250 Hz bandwidth would enable a shorter burst, even as low as 4 or 5 ms.

As also noted above, a delay can be imposed on successive drive signals to direct the sonar beam 50 (shown schematically in FIG. 8). This provides additional flexibility for directing the beam 50 towards an area of interest or away from something that should be avoided. This also allows periodic monitoring to track the progression of an oilfield and to target the movement of the oil reserves. Since the arrangement 16 is situated at the seabed, periodic monitoring can be done without having to arrange for a ship to tow the equipment or for arranging environmental approvals as would need to be done with an air gun solution.

Turning now to FIG. 14, an inclinometer 70 is advantageously included with the transducer arrangement 16 such that as the transducer arrangement 16 is deployed, the relative position of the transducer arrangement 16 with respect to the seabed can be determined. This information can be used to calculate an angle β, which in turn can be used to direct the beam 50 downwards. If this orientation is not known, a normal beam 50 would simply pass through the peak in the seabed (as shown in ghosted lines). Therefore, it can be appreciated that additional sensors and/or electronics can be used to improve the accuracy of the system 10. For example, the angle β can be transmitted to the controller 12, e.g. using a suitable sonar “ping” arrangement and a hydrophone (not shown), to enable the controller 12 to redirect the beam accordingly. This can be accomplished by selecting from a library of predetermined beamsteering algorithms or by computing a new pattern in real time. Similarly, a sonar ping transducer can be used to locate the arrangement 16 should it become detached from the cable 17. This would enable the arrangement 16 to be retrieved in an emergency or should an accident occur. Preferably, a battery-powered locator should be used rather than relying on the communication channel provided by the cable 17 for these emergency situations.

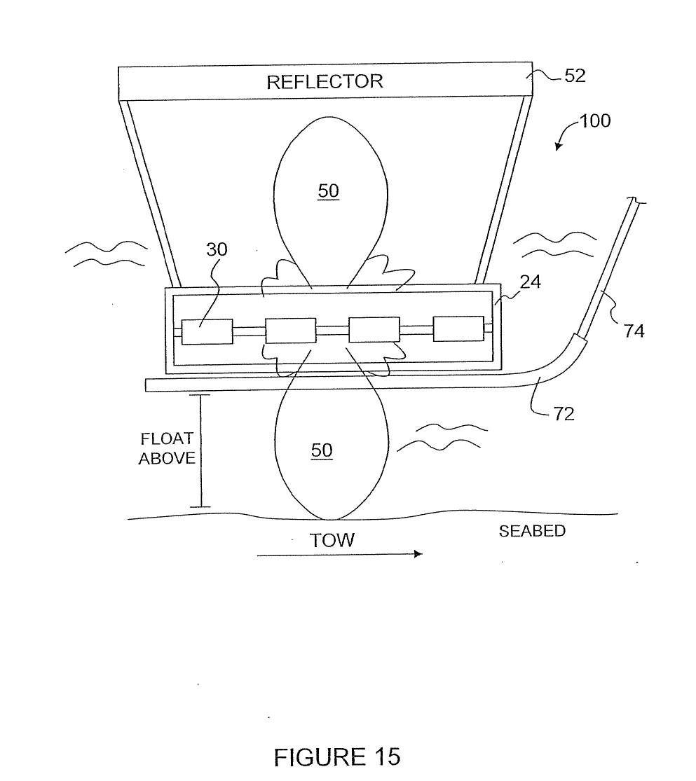

In other applications, a towed arrangement 100 could also be deployed as shown in FIG. 15. In this configuration, a sled 72 is provided to enable the rack 24 to travel at various distances above the seabed. A tow cable 74 attached to the sled 72 would pull the rack 24 and thus the arrangement 100 over the seabed. This arrangement would allow the system 10 to be used to provide a sweep of the seabed to determine if further exploration is warranted. However, it should be noted that the speed at which the arrangement 100 moves over the seabed surface should be carefully tracked so that any smearing in the received signal (due to the movement) can be compensated. In a towed application, the use of an inclinometer 70 would also be particularly suitable to stabilize the beam 50 according to the changing orientation of the sled 72. In addition to being towed, an autonomous arrangement (not shown) can be used where a sled 72 or similar underwater vessel is controlled and the system 10 operated from the sled 72 or vessel to remotely and/autonomously conduct a survey over time and over a specified geographical area.

It can therefore be seen that the use of suitable low frequency acoustic transducers for seismic applications enables a more complex signal to used while increasing the effective power level and keeping the peak power down to a fraction of this effective power. The transducers can be driven using a pseudo-random coding of chirps that change frequency in each contiguous burst within the chirp and the interval between chirps varied to provide a pseudo-random duty cycle. In this way, each chirp can be different allowing multiple signals to be present in the water at the same time. By changing the timing of the drive signal for specific transducers, the direction of the source beam can be altered to steer the beam towards or away from certain objects or areas. The system 10 described above can be implemented with existing and/or off the shelf receiving equipment enabling the additional features to be utilized without replacing the receiving equipment.

Although the above principles have been described with reference to certain specific embodiments, various modifications thereof will be apparent to those skilled in the art without departing from the scope of the claims appended hereto.

1. A method for providing an underwater seismic source for a data acquisition system comprising locating an orderly arrangement of a plurality of low frequency acoustic transducers at a seabed; generating a drive signal for each transducer; and applying respective drive signal to respective transducers to generate said seismic source.

2. The method according to claim 1 wherein said drive signal comprises a series of chirps each comprising a series of bursts, each burst being at a different frequency.

3. The method according to claim 1 wherein said transducers are of a type chosen from one or more of the following transducer types: piezoelectric, magnetorestrictive, and barrel stave.

4. The method according to claim 1 wherein said orderly arrangement defines an array.

5. The method according to claim 1 wherein said locating comprises supporting said transducers using a structure and placing said structure at said seabed.

6. The method according to claim 1 further comprising supporting a reflector above said transducers for interacting with upwardly directed beams generated by said transducers.

7. The method according to claim 1 wherein said drive signal is applied according to a pre-generated waveform.

8. The method according to claim 1 wherein said drive signal incorporates beam steering by delaying firing of selected ones of said transducers with respect to others of said transducers.

9. A system for generating an underwater seismic source for a data acquisition system comprising a controller at the surface, an orderly arrangement of a plurality of low frequency acoustic transducers at the seabed, and a communication link connecting said controller to said transducers, said controller configured to generate a drive signal for each transducer and to apply respective drive signals to respective transducers to generate said seismic source.

10. The system according to claim 9 wherein said drive signal comprises a series of chirps each comprising a series of bursts, each burst being at a different frequency.

11. The system according to claim 9 wherein said transducers are of a type chosen from one or more of the following transducer types: piezoelectric, magnetorestrictive, and barrel stave.

12. The system according to claim 9 wherein said orderly arrangement defines an array.

13. The system according to claim 9 further comprising a reflector supported above said transducers for interacting with upwardly directed beams generated by said transducers.

14. The system according to claim 9 configured to apply said drive signal according to a pre-generated waveform.

15. The system according to claim 9 wherein said drive signal incorporates beam steering by delaying firing of selected ones of said transducers with respect to others of said transducers.

16. A method for generating a drive signal for creating a seismic source from an orderly arrangement of a plurality of low frequency acoustic transducers positioned at a seabed comprising: obtaining a waveform indicative of a frequency pattern at which to drive said seismic source during a chirp; transmitting an intermediate signal to said transducers according to said waveform; and utilizing a different waveform for each of a plurality of chirps.

17. The method according to claim 16 wherein said plurality of chirps are spaced according to a plurality of intervals to provide a pseudo-random pattern of chirps.

18. The method according to claim 16 further comprising providing a record of said waveform to a receiver system to enable said receiver system to decode beams returning from said source.

19. A method for controlling a drive signal for an underwater seismic source, said method comprising: providing an orderly arrangement of a plurality of low frequency acoustic transducers in a structure at a seabed, said structure comprising an inclinometer for measuring an angle of said transducers with respect to said seabed; measuring said angle using said inclinometer; providing said angle to a controller configured for operating said transducers according to a drive signal; and adjusting said drive signal to steer a resultant beam from said source according to said angle.

20. The method according to claim 19 repeated over time as said transducers are moved over said seabed to continually adjust said angle according to changes in said seabed.

21. An underwater seismic source comprising a structure configured to support said source at a seabed, said source comprising an orderly arrangement of a plurality of low frequency acoustic transducers; and a communication link to a controller to receive drive signals for said transducers from said controller.

22. The underwater seismic source according to claim 21, further comprising a reflector supported above said structure for interacting with upwardly directed beams generated by said transducers.

23. The underwater seismic source according to claim 22 wherein said reflector interacts with said upwardly directed beams by reflecting said beams back towards said seabed.

24. The underwater seismic source according to claim 22 wherein said reflector interacts with said upwardly directed beams by absorbing or dispersing said beams.

25. The underwater seismic source according to claim 21 further comprising a towing linkage for attaching a tow cable to enable said seismic source to be towed.

26. The underwater seismic source according to claim 21 further comprising a drive system for moving said seismic source underwater.

27. An autonomous underwater vehicle comprising the underwater seismic source according to claim 21.

28. A method for generating a drive signal for creating a seismic source from an orderly arrangement of a plurality of low frequency acoustic transducers comprising generating a waveform indicative of a frequency pattern at which to drive said seismic source by: defining a plurality of chirps; and separating said plurality of chirps in said waveform according to a plurality of intervals.

29. The method according to claim 28 further comprising recording an indication of said intervals to enable a surface receiver to decode a received signal.

30. The method according to claim 28 further comprising defining a frequency pattern within at least one of said chirps and recording said frequency pattern to enable a surface receiver to decode a received signal.
